(19) United States
(12) Patent Application Publication
(10) Pub. No.: US 2022/0105852 A1
(43) Pub. Date: Apr. 7, 2022

(54) HANDCART

(71) Applicant: MAKITA CORPORATION, Anjo-shi (JP)

(72) Inventors: Koki TERAMOTO, Anjo-shi (JP); Ryo SUNAZUKA, Anjo-shi (JP); Tomoyuki KUTSUNA, Anjo-shi (JP); Susumu KATO, Anjo-shi (JP); Tomonobu NASHIMOTO, Anjo-shi (JP); Toshihiro TOMITA, Anjo-shi (JP)

(73) Assignee: MAKITA CORPORATION, Anjo-shi (JP)

(21) Appl. No.: 17/495,444

(22) Filed: Oct. 6, 2021

(30) Foreign Application Priority Data
Oct. 7, 2020 (JP) 2020-169928

(51) Int. Cl. B60P 1/04; B62B 3/08; B60Q 9/00

(52) U.S. Cl. CPC B60P 1/045; B60Q 9/00; B62B 3/08

(57) ABSTRACT

A handcart may include: a front wheel; a rear wheel; a support frame supporting the front wheel and the rear wheel; a receptacle pivotable relative to the support frame; a load sensor configured to detect a load applied to the rear wheel; and a control unit. When the load detected by the load sensor is less than or equal to a predetermined load, the control unit may be configured to determine that the rear wheel is predicted to lift from a ground.

### CROSS-REFERENCE TO RELATED APPLICATION

This application claims priority to Japanese Patent Application No. 2020-169928 filed on Oct. 7, 2020, the contents of which are hereby incorporated by reference into the present application.

### TECHNICAL FIELD

The teachings disclosed herein relate to handcarts.

### BACKGROUND ART

U.S. Pat. No. 4,645,264 describes a handcart including a front wheel, a rear wheel, a support frame, a receptacle pivotable relative to the support frame, and a control unit.

### SUMMARY

The handcart of U.S. Pat. No. 4,645,264 unloads an object (e.g., sand) in the receptacle by tilting the receptacle relative to the support frame. If the object in the receptacle is something difficult to adhere to the receptacle (e.g., dry sand), it is unloaded from the receptacle by tilting the receptacle relative to the support frame. However, if the object in the receptacle is something that easily adheres to the receptacle (e.g., argilliferous soil), a part of the object may not be unloaded from the receptacle even by tilting the receptacle relative to the support frame. Specifically, a part of the object that is adhering to a lower portion of the receptacle may not be unloaded. As the receptacle is tilted relative to the support frame in such a situation, the position of the center of gravity of the handcart shifts forward greatly. The large forward shift in the position of the center of gravity of the handcart may cause the rear wheel of the handcart to lift from the ground.

The disclosure herein provides techniques that can improve safety in using a handcart.

A handcart disclosed herein may comprise: a front wheel; a rear wheel; a support frame supporting the front wheel and the rear wheel; a receptacle pivotable relative to the support frame; a load sensor configured to detect a load applied to the rear wheel; and a control unit. When the load detected by the load sensor is less than or equal to a predetermined load, the control unit may be configured to determine that the rear wheel is predicted to lift from a ground.

According to the above configuration, the control unit can determine that the rear wheel is predicted to lift from the ground by using the load detected by the load sensor. Thus, even if an object in the receptacle is something that easily adheres to the receptacle, it is possible to suppress the position of the center of gravity of the handcart from shifting forward to an extent that the rear wheel of the handcart lifts from the ground. It is thus possible to suppress the rear wheel of the handcart from lifting from the ground and improve safety in using the handcart.

A handcart disclosed herein may comprise: a front wheel; a rear wheel; a support frame supporting the front wheel and the rear wheel; a receptacle pivotable relative to the support frame; an angle sensor configured to detect an angle of the support frame with respect to a reference plane in a front-rear direction; and a control unit. When the angle detected by the angle sensor is greater than or equal to a predetermined angle, the control unit may be configured to determine that the rear wheel is predicted to lift from a ground.

According to the above configuration, the control unit can determine that the rear wheel is predicted to lift from the ground by using the angle detected by the angle sensor. Thus, even if an object in the receptacle is something that easily adheres to the receptacle, it is possible to suppress the position of the center of gravity of the handcart from shifting forward to an extent that the rear wheel of the handcart lifts from the ground. It is thus possible to suppress the rear wheel of the handcart from lifting from the ground and improve the safety in using the handcart.

A handcart disclosed herein may comprise: a front wheel; a rear wheel; a support frame supporting the front wheel and the rear wheel; a receptacle pivotable relative to the support frame; a displacement detector for specifying a displacement of the rear wheel; and a control unit. When the displacement is smaller than or equal to a predetermined value, the control unit may be configured to determine that the rear wheel is predicted to lift from a ground.

According to the above configuration, the control unit can determine that the rear wheel is predicted to lift from the ground by using the displacement of the rear wheel. Thus, even if an object in the receptacle is something that easily adheres to the receptacle, it is possible to suppress the position of the center of gravity of the handcart from shifting forward to an extent that the rear wheel of the handcart lifts from the ground. It is thus possible to suppress the rear wheel of the handcart from lifting from the ground and improve the safety in using the handcart.

### BRIEF DESCRIPTION OF THE DRAWINGS

FIG. 1 is a perspective view of a cart 2 according to first, second, and third embodiments, as viewed from the upper front right side.

FIG. 2 is a perspective view of a chassis unit 4 according to the first, second, and third embodiments, as viewed from the upper front right side.

FIG. 3 is a right side view of the cart 2 in the state illustrated in FIG. 1.

FIG. 4 is a perspective view of the cart 2 according to the first, second, and third embodiments, as viewed from the upper front right side, where a pivotable frame 34 is tilted relative to a fixed frame 30.

FIG. 5 is a right side view of the cart 2 in the state illustrated in FIG. 4.

FIG. 6 is a perspective view of the cart 2 according to the first, second, and third embodiments, as viewed from the upper front right side, where the pivotable frame 34 is tilted relative to the fixed frame 30 and a receptacle frame 38 is tilted relative to the pivotable frame 34.

FIG. 7 is a right side view of the cart 2 in the state illustrated in FIG. 6.

FIG. 8 is a perspective view of a receptacle unit 6 according to the first, second, and third embodiments, as viewed from the upper rear left side.

FIG. 9 is a block diagram illustrating a control system configuration of the cart 2 according to the first, second, and third embodiments.

FIG. 10 is a flowchart of a detection process according to the first embodiment.

FIG. 11 is a diagram illustrating a relationship between rear load F and pivot angles in the first embodiment.

FIG. 12 is a diagram illustrating a frame angle A according to the second embodiment.

FIG. 13 is a diagram illustrating a relationship between frame angle A and pivot angles in the second embodiment.

FIG. 14 is a diagram illustrating a reference distance L according to the third embodiment.

FIG. 15 is a diagram illustrating a relationship between displacement S and pivot angles in the third embodiment.

### DETAILED DESCRIPTION

Representative, non-limiting examples of the disclosure herein will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved handcarts, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a handcart may comprise: a front wheel; a rear wheel; a support frame supporting the front wheel and the rear wheel; a receptacle pivotable relative to the support frame; a load sensor configured to detect a load applied to the rear wheel; and a control unit. When the load detected by the load sensor is less than or equal to a predetermined load, the control unit may be configured to determine that the rear wheel is predicted to lift from a ground.

In one or more embodiments, a handcart disclosed herein may comprise: a front wheel; a rear wheel; a support frame supporting the front wheel and the rear wheel; a receptacle pivotable relative to the support frame; an angle sensor configured to detect an angle of the support frame with respect to a reference plane in a front-rear direction; and a control unit. When the angle detected by the angle sensor is greater than or equal to a predetermined angle, the control unit may be configured to determine that the rear wheel is predicted to lift from a ground.

In one or more embodiments, a handcart disclosed herein may comprise: a front wheel; a rear wheel; a support frame supporting the front wheel and the rear wheel; a receptacle pivotable relative to the support frame; a displacement detector for specifying a displacement of the rear wheel; and a control unit. When the displacement is smaller than or equal to a predetermined value, the control unit may be configured to determine that the rear wheel is predicted to lift from a ground.

In one or more embodiments, the handcart may further comprise a notifier. The control unit may be configured to activate the notifier when determining that the rear wheel is predicted to lift from the ground.

According to the above configuration, a user can be notified that the rear wheel may lift from the ground in response to pivoting the receptacle relative to the support frame. Thus, safety in using the handcart can be improved.

In one or more embodiments, the handcart may further comprise an actuator configured to pivot the receptacle relative to the support frame. The control unit may be configured to control an operation of the actuator.

According to the above configuration, the user does not have to manually pivot the receptacle relative to the support frame. Thus, user convenience can be improved.

In one or more embodiments, under a state where the actuator is in operation, the control unit may be configured to stop the operation of the actuator when determining that the rear wheel is predicted to lift from the ground.

According to the above configuration, the rear wheel can be suppressed from lifting from the ground since the operation of the actuator is stopped. Thus, the safety in using the handcart can be improved.

In one or more embodiments, when determining that the rear wheel is predicted to lift from the ground under a state where the actuator is in operation and an angle between the support frame and the receptacle is a first angle, the control unit may be configured to control the operation of the actuator such that the angle between the support frame and the receptacle becomes a second angle that is smaller than the first angle.

According to the above configuration, the control unit reduces the angle between the support frame and the receptacle when determining that the rear wheel is predicted to lift from the ground. Thereby, the position of the center of gravity of the handcart shifts rearward. Thus, it is possible to further ensure that the rear wheel is prevented from lifting from the ground.

### First Embodiment

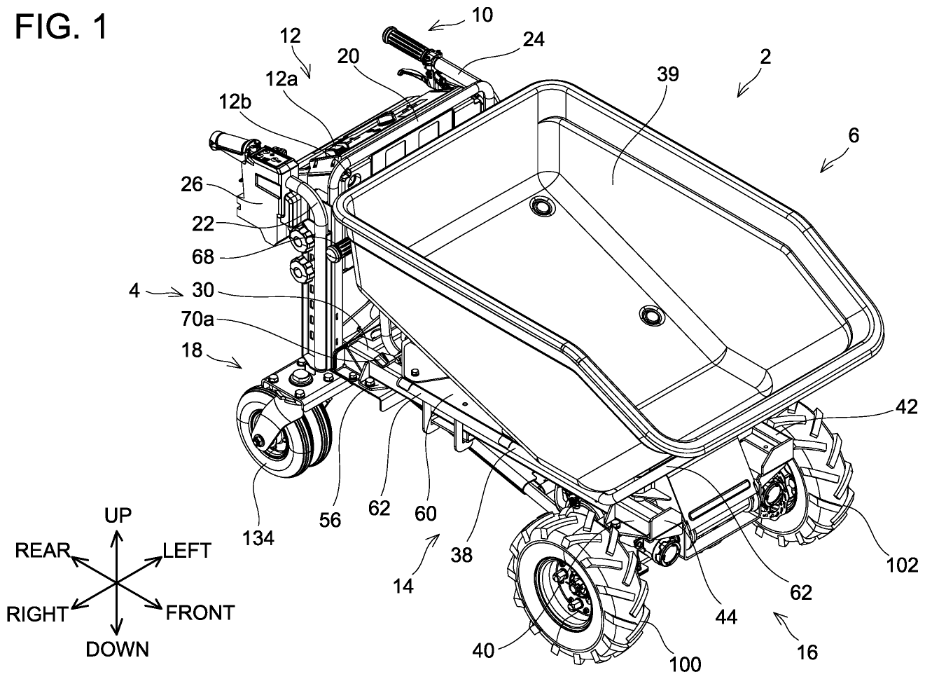

Referring to FIGS. 1 to 9, a cart 2 will be described. The cart 2 is a handcart. As illustrated in FIGS. 1 to 9, the cart 2 comprises a chassis unit 4 and a receptacle unit 6.

(Configuration of Chassis Unit 4)

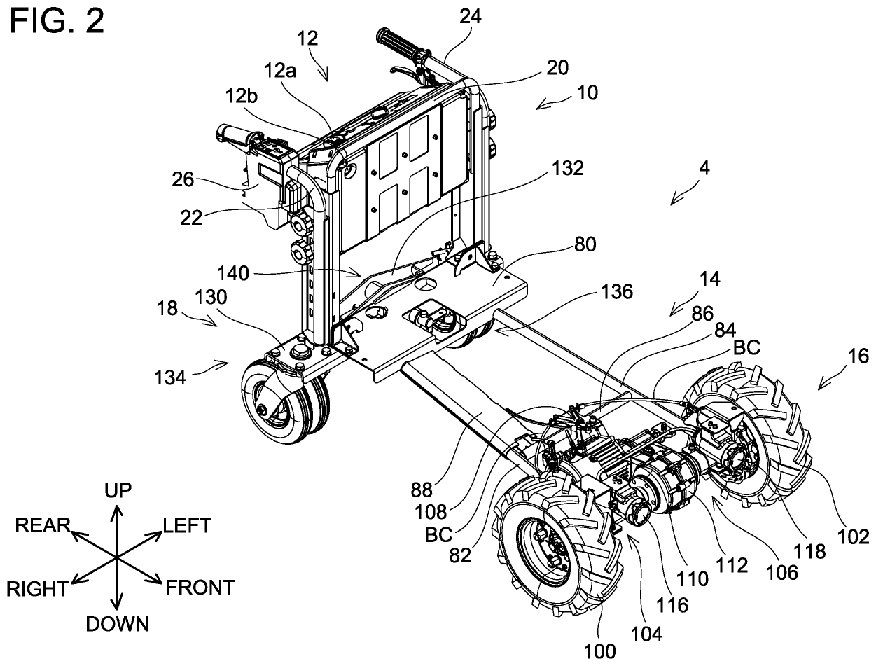

As illustrated in FIG. 2, the chassis unit 4 comprises a handle unit 10, a battery box 12, a chassis frame 14, a front wheel unit 16, and a rear wheel unit 18.

(Configuration of Chassis Frame 14)

As illustrated in FIG. 2, the chassis frame 14 comprises a frame plate 80, a right frame pipe 82, a left frame pipe 84, and a middle frame pipe 86. The rear wheel unit 18 is attached to the frame plate 80. The right frame pipe 82 and the left frame pipe 84 are welded to the frame plate 80 at their rear ends and extend forward. An interval between the right frame pipe 82 and the left frame pipe 84 widens from their rear ends toward their front ends. The front wheel unit 16 is attached to the front ends of the right frame pipe 82 and the left frame pipe 84. The middle frame pipe 86 is located near the front wheel unit 16. A right end of the middle frame pipe 86 is welded to the right frame pipe 82 and a left end thereof is welded to the left frame pipe 84. A cable cover 88 is attached to the right frame pipe 82. The cable cover 88 protects a charge cable (not illustrated) connecting the battery box 12 with a right headlight 116 and a left headlight 118, and a power cable (not illustrated) connecting the battery box 12 with a motor 110.

(Configuration of Front Wheel Unit 16)

As illustrated in FIG. 2, the front wheel unit 16 comprises a right front wheel 100, a left front wheel 102, a right front wheel brake 104, a left front wheel brake 106, a brake equalizer 108, the motor 110, a gear box 112, the right headlight 116, and the left headlight 118. The right front wheel 100 is connected to the gear box 112 via a right drive shaft (not illustrated). The left front wheel 102 is connected to the gear box 112 via a left drive shaft (not illustrated). The right front wheel brake 104 and the left front wheel brake 106 are disk brakes and configured to stop movements of the right front wheel 100 and the left front wheel 102, respectively. The brake equalizer 108 is connected to the right front wheel brake 104 and the left front wheel brake 106 via brake cables BC. The gear box 112 is connected to the motor 110. The gear box 112 transmits input from the motor 110 to the right and left drive shafts.

(Configuration of Rear Wheel Unit 18)

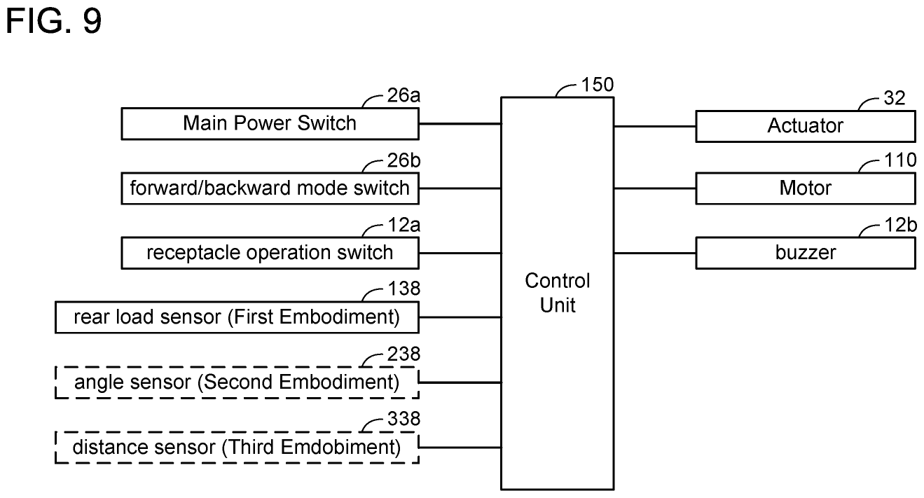

As illustrated in FIG. 2, the rear wheel unit 18 comprises a base plate 130, a hinge 132, a right rear wheel 134, a left rear wheel 136, and a rear load sensor 138 (see FIG. 9). The right rear wheel 134 is connected to a right end portion of the base plate 130 and the left rear wheel 136 is connected to a left end portion thereof. The hinge 132 is welded to an upper surface of the base plate 130. Hereinbelow, the base plate 130 and the hinge 132 may collectively be termed a rear wheel frame 140. The rear load sensor 138 is disposed at the hinge 132. In a variant, the rear load sensor 138 may be disposed at the base plate 130.

(Configuration of Handle Unit 10)

As illustrated in FIG. 2, the handle unit 10 comprises a handle base 20, a right handle 22, and a left handle 24. The right handle 22 and the left handle 24 are screwed to the handle base 20. The handle base 20 is screwed to the frame plate 80 of the chassis frame 14. The battery box 12 is screwed to the handle base 20. A switch box 26 is disposed on the right handle 22. On the switch box 26, a main power switch 26a (see FIG. 9), a forward/backward mode switch 26b (see FIG. 9), etc., are disposed.

(Configuration of Battery Box 12)

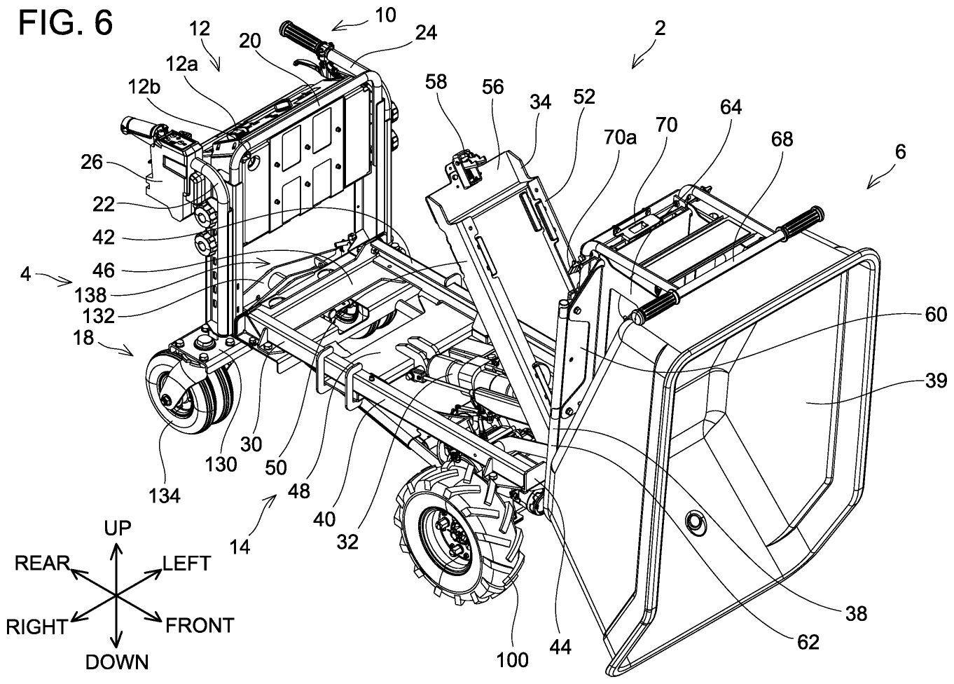

The battery box 12 houses a battery pack (not illustrated) and a control unit 150 (see FIG. 9). As illustrated in FIG. 2, on the battery box 12, a receptacle operation switch 12a for operating an actuator 32 (which will be described later, see FIG. 6), a remaining charge display (not illustrated) that displays remaining battery charge of the battery pack, etc., are disposed. Further, a buzzer 12b is disposed on a front surface of the battery box 12.

(Configuration of Receptacle Unit 6)

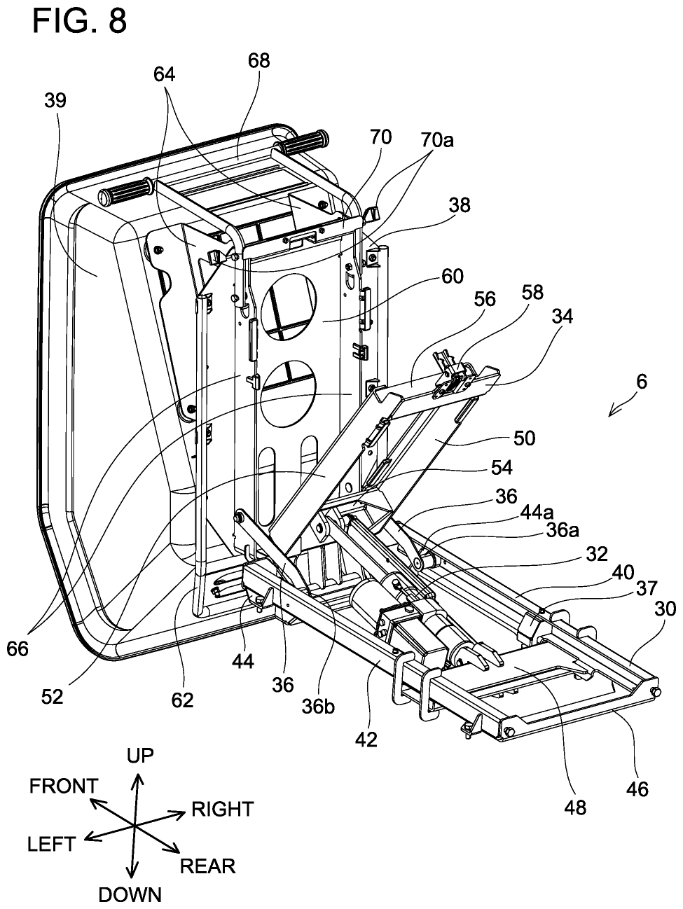

As illustrated in FIG. 8, the receptacle unit 6 comprises a fixed frame 30, the actuator 32, a pivotable frame 34, support arms 36, a receptacle frame 38, and a bucket 39. The bucket 39 has a shape of upwardly open box.

As illustrated in FIG. 6, the fixed frame 30 comprises a right channel 40, a left channel 42, a front plate 44, a rear plate 46, and a reinforcement frame 48. The right channel 40 and the left channel 42 extend in a front-rear direction. The front plate 44 is welded to front ends of the right channel 40 and the left channel 42. The rear plate 46 is welded to rear ends of the right channel 40 and the left channel 42. The front plate 44 and the rear plate 46 are screwed to the chassis frame 14. The reinforcement frame 48 extends in a right-left direction, is welded to the right channel 40 at its right end, and is welded to the left channel 42 at its left end. The actuator 32 is connected to a front surface of the reinforcement frame 48.

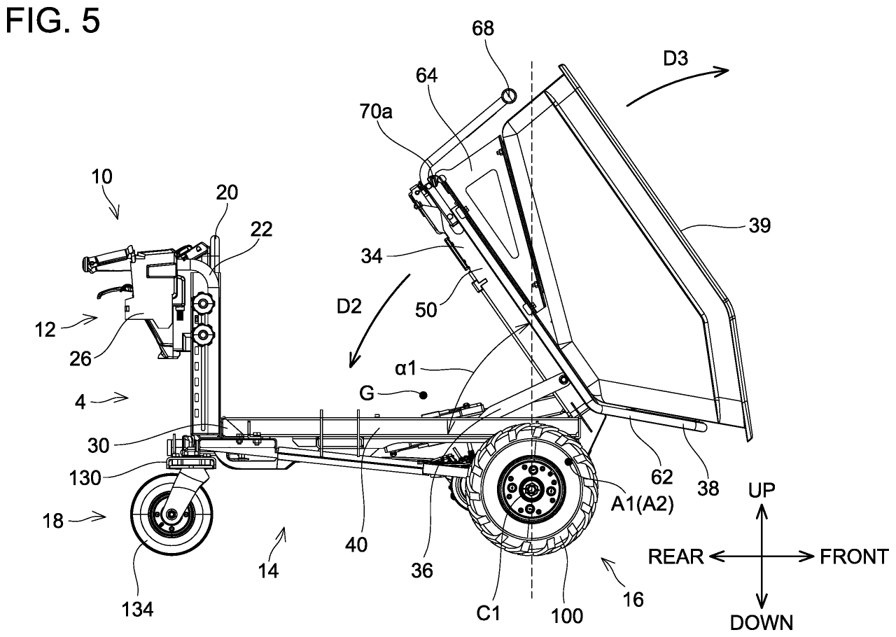

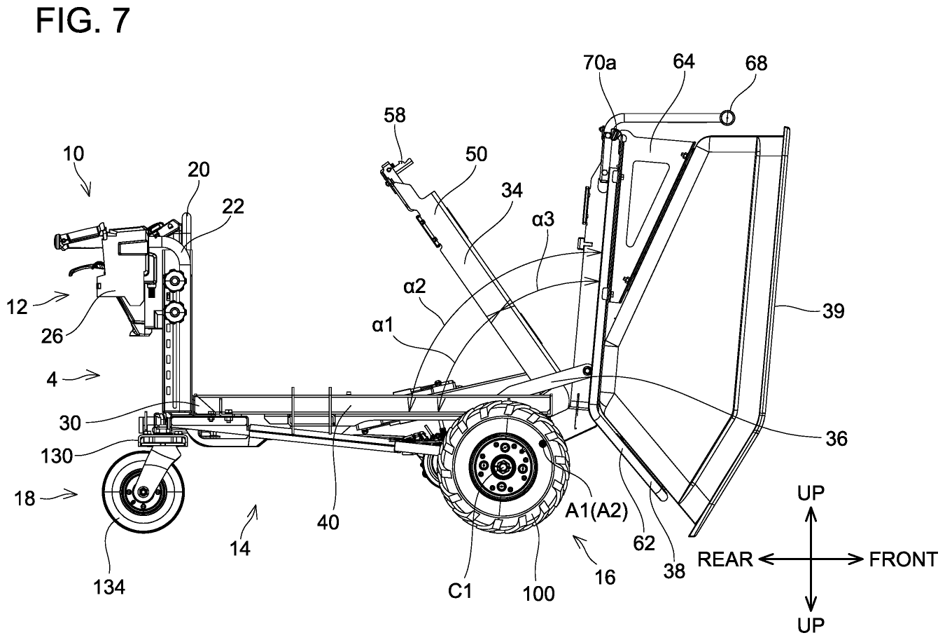

As illustrated in FIG. 8, the pivotable frame 34 comprises a right frame 50, a left frame 52, a front frame 54, a rear frame 56, and a latch receiver 58. The right frame 50 and the left frame 52 extend in the front-rear direction. Front ends of the right frame 50 and the left frame 52 are connected to a front end of the front plate 44 of the fixed frame 30 and a front end of a lower frame 66 of the receptacle frame 38 (which will be described later) in such a way that the right frame 50 and the left frame 52 are pivotable about a pivot axis A1 (see FIGS. 5 and 7) which is along the right-left direction. The pivot axis A1 is located forward of a rotation axis Cl of the right front wheel 100. The front frame 54 extends in the right-left direction between the vicinity of the front end of the right frame 50 and the vicinity of the front end of the left frame 52. The rear frame 56 extends in the right-left direction between a rear end of the right frame 50 and a rear end of the left frame 52. The latch receiver 58 is fixed to the vicinity of the center of the rear frame 56. The latch receiver 58 is arranged at the position corresponding to a latch mechanism 70 of the receptacle frame 38 (which will be described later).

As illustrated in FIG. 8, the receptacle frame 38 comprises a base plate 60, a base pipe 62, an upper frame 64, the lower frame 66, a handle 68 grippable by a user, and the latch mechanism 70. The base plate 60 is arranged along the front-rear direction and the right-left direction. The base pipe 62 extends along a lower surface of a lower front portion of the bucket 39 in the right-left direction and extends along a lower surface of the base plate 60 in the front-rear direction. The base pipe 62 is screwed to the lower front portion of the bucket 39 as well as the base plate 60. The upper frame 64 is arranged along the front-rear direction and an up-down direction between a lower surface of a lower rear portion of the bucket 39 and an upper surface of the base plate 60. The upper frame 64 is screwed to the lower rear portion of the bucket 39 as well as the base plate 60. The lower frame 66 extends along the lower surface of the base plate 60 in the front-rear direction. The front end of the lower frame 66 is connected to the front end of the front plate 44 of the fixed frame 30 in such a way that the lower frame 66 is pivotable about a pivot axis A2 (see FIGS. 5 and 7) which is along the right-left direction. As illustrated in FIGS. 5 and 7, the pivot axis A2 is coincident with the pivot axis A1. As illustrated in FIG. 8, the handle 68 is located rearward of the bucket 39. The handle 68 is screwed to the lower frame 66. The latch mechanism 70 is located below the handle 68. The latch mechanism 70 is fixed to the base plate 60 and the lower frame 66. The latch mechanism 70 comprises a latch releasing knob 70a. When the receptacle frame 38 pivots relative to the pivotable frame 34 in a direction that brings a rear end of the receptacle frame 38 closer to a rear end of the pivotable frame 34, the latch mechanism 70 engages with the latch receiver 58. The engagement of the latch mechanism 70 with the latch receiver 58 is released in response to the user manipulating the latch releasing knob 70a while the latch mechanism 70 is in engagement with the latch receiver 58. While the latch mechanism 70 is in engagement with the latch receiver 58, the receptacle frame 38 rests on the pivotable frame 34.

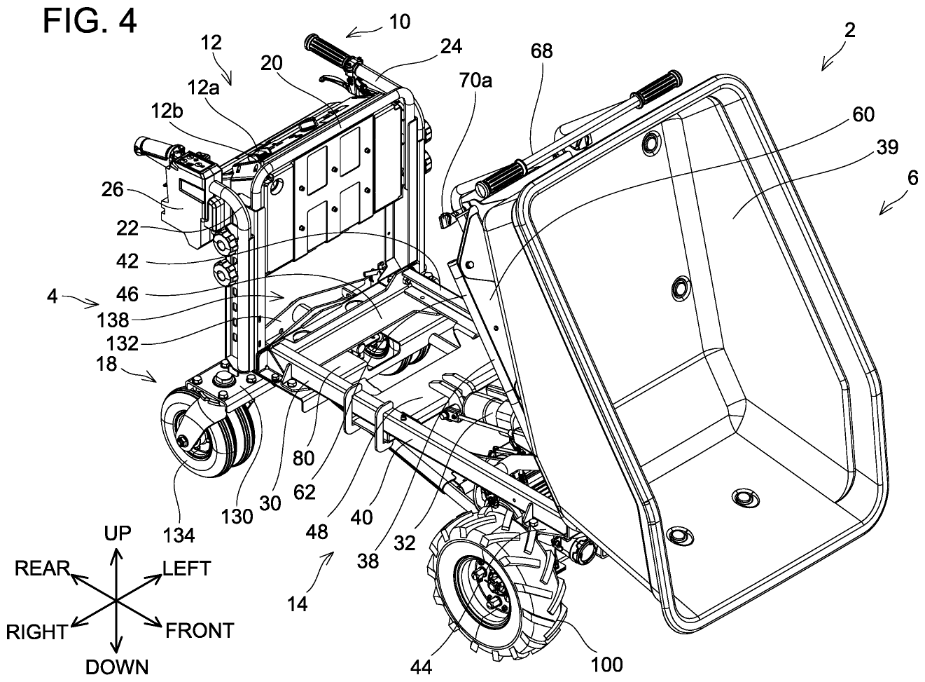

Upper ends of the support arms 36 illustrated in FIG. 8 are connected to the vicinity of the front end of the lower frame 66 of the receptacle frame 38. The support arms 36 comprise rollers 36a and 36b at their lower ends, respectively. The rollers 36a and 36b are respectively held to be movable in the front-rear direction within the right channel 40 and the left channel 42 of the fixed frame 30. A front stopper 44a of the front plate 44 of the fixed frame 30 is disposed within the right channel 40. Further, a rear stopper 37 is disposed rearward of the front stopper 44a within the right channel 40. The movable range of the roller 36a in the front-rear direction is limited by the front stopper 44a and the rear stopper 37. A front stopper and a rear stopper are disposed also within the left channel 42 to limit the movable range of the roller 36b in the front-rear direction, although this is not illustrated. As illustrated in FIGS. 4 and 5, while the latch mechanism 70 is in engagement with the latch receiver 58, the pivotable frame 34 and the receptacle frame 38 integrally pivot relative to the fixed frame 30. As illustrated in FIGS. 6 and 7, while the latch mechanism 70 is not in engagement with the latch receiver 58, the receptacle frame 38 pivots relative to the fixed frame 30 and the pivotable frame 34.

The actuator 32 illustrated in FIG. 8 is a linear actuator configured to execute a contracting operation and an expanding operation, for example, a hydraulic cylinder. The actuator 32 is connected to a hydraulic pump (not illustrated). One end of the actuator 32 is supported on the reinforcement frame 48 of the fixed frame 30 in such a way that the actuator 32 is pivotable about a pivot axis which is the right-left direction. Another end of the actuator 32 is supported on the front frame 54 of the pivotable frame 34 in such a way that the actuator 32 is pivotable about the pivot axis which is the right-left direction. The actuator 32 is connected to the battery box 12 of the chassis unit 4 via a power cable (not illustrated). The actuator 32 is supplied with power from the battery pack (not illustrated) in the battery box 12. The operation of the actuator 32 is controlled by the control unit 150 (see FIG. 9).

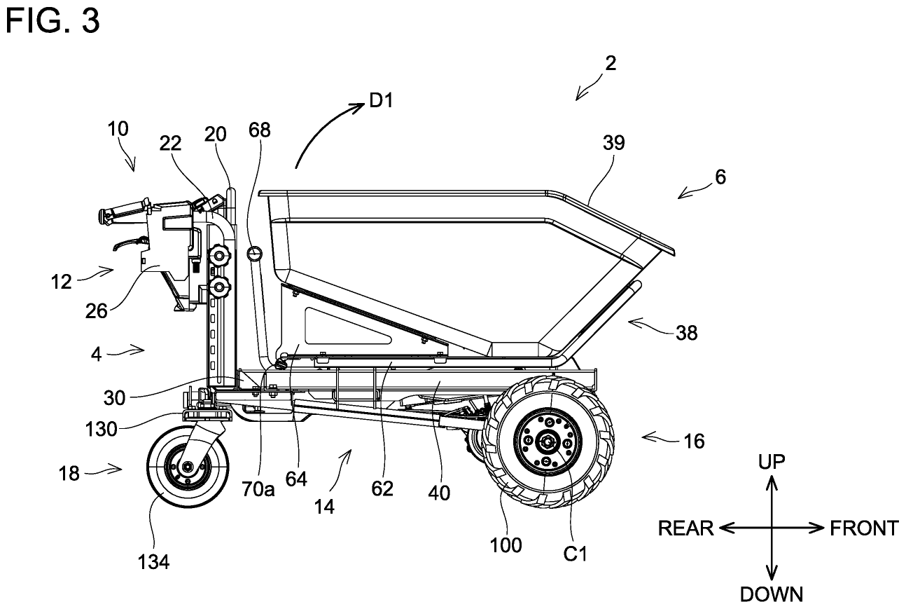

Referring to FIGS. 1 and 3 to 5, how the pivotable frame 34 moves in response to the contraction operation and the expanding operation of the actuator 32 will be described. When the actuator 32 executes the expanding operation in the state illustrated in FIG. 3, the pivotable frame 34 pivots relative to the fixed frame 30 in a direction D1 that brings the rear end of the pivotable frame 34 away from a rear end of the fixed frame 30. When the actuator 32 executes the contracting operation in the state illustrated in FIG. 5, the pivotable frame 34 pivots relative to the fixed frame 30 in a direction D2 that brings the rear end of the pivotable frame 34 closer to the rear end of the fixed frame 30. In the most expanded state of the actuator 32, the pivotable frame 34 and the receptacle frame 38 are tilted to the fixed frame 30 and the angle between the fixed frame 30 and the pivotable frame 34 is a first pivot angle α1. The angle between the fixed frame 30 and the receptacle frame 38 is substantially the same as the first pivot angle α1.

As illustrated in FIG. 5, the first pivot angle α1 is an angle that makes the position of the center of gravity G of the cart 2 in the front-rear direction located rearward of the rotation axis Cl of the right front wheel 100 under the state where the pivot angle of the pivotable frame 34 and the receptacle frame 38 relative to the fixed frame 30 is the first pivot angle α1. The center of gravity G of the cart 2 illustrated in FIG. 5 is the center of gravity of the cart 2 with the bucket 39 being empty.

When the user releases the engagement of the latch mechanism 70 with the latch receiver 58 by manipulating the latch releasing knob 70a in the state illustrated in FIGS. 4 and 5, the receptacle frame 38 can be pivoted in a direction D3 relative to the pivotable frame 34 and the fixed frame 30. As illustrated in FIGS. 6 and 7, the user can cause the receptacle frame 38 to pivot up to when the angle between the fixed frame 30 and the receptacle frame 38 becomes a second pivot angle α2. The second pivot angle α2 is larger than the first pivot angle α1 by a third pivot angle α3. The pivotable range of the receptacle frame 38 relative to the fixed frame 30 is defined by the front stopper 44a and the rear stopper 37 within the right channel 40 of the fixed frame 30 and the front stopper and the rear stopper within the left channel 42.

(Control Configuration of Cart 2; FIG. 9)

Next, referring to FIG. 9, a control configuration of the cart 2 will be described. The control unit 150 housed in the battery box 12 comprises a computer including a CPU, ROM, and RAM. The main power switch 26a, the forward/backward mode switch 26b, the receptacle operation switch 12a, the rear load sensor 138, the actuator 32, the motor 110, and a buzzer 12b are connected to the control unit 150. The control unit 150 controls and causes the actuator 32 to execute the expanding operation while the user is pushing an upper portion of the receptacle operation switch 12a. The control unit 150 controls and causes the actuator 32 to execute the contracting operation while the user is pushing a lower portion of the receptacle operation switch 12a. Hereinbelow, the operation of the user pushing the upper portion of the receptacle operation switch 12a and the operation of the user pushing the lower portion of the receptacle operation switch 12a may be termed “lifting operation” and “lowering operation”, respectively.

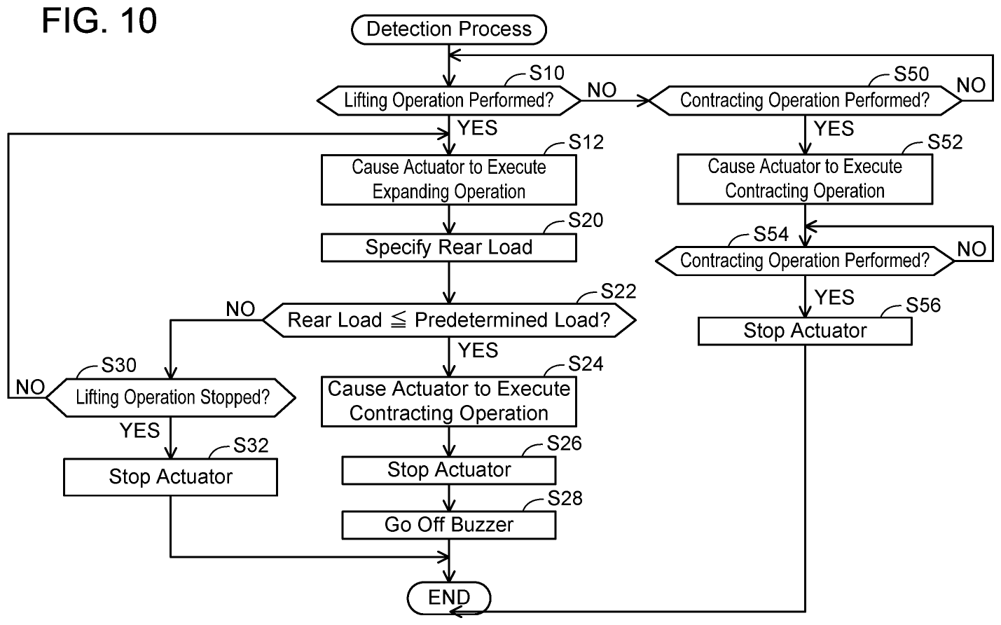

(Detection Process; FIG. 10)

Next, referring to FIG. 10, a detection process executed by the control unit 150 of the cart 2 will be described. The control unit 150 executes the process of FIG. 10 when the power of the cart 2 is on. At the beginning of the process of FIG. 10, the actuator 32 is not in operation.

In S10, the control unit 150 determines whether the upper portion of the receptacle operation switch 12a is being manipulated, that is, whether the lifting operation is being performed. If the lifting operation is being performed, the control unit 150 determines YES in S10 and the process proceeds to S12. On the other hand, if the lifting operation is not being performed, the control unit 150 determines NO in S10 and the process proceeds to S50.

In S12, the control unit 150 controls and causes the actuator 32 to execute the expanding operation.

In S20, the control unit 150 specifies a load F detected by the rear load sensor 138 (which may be termed “the rear load F” hereinbelow).

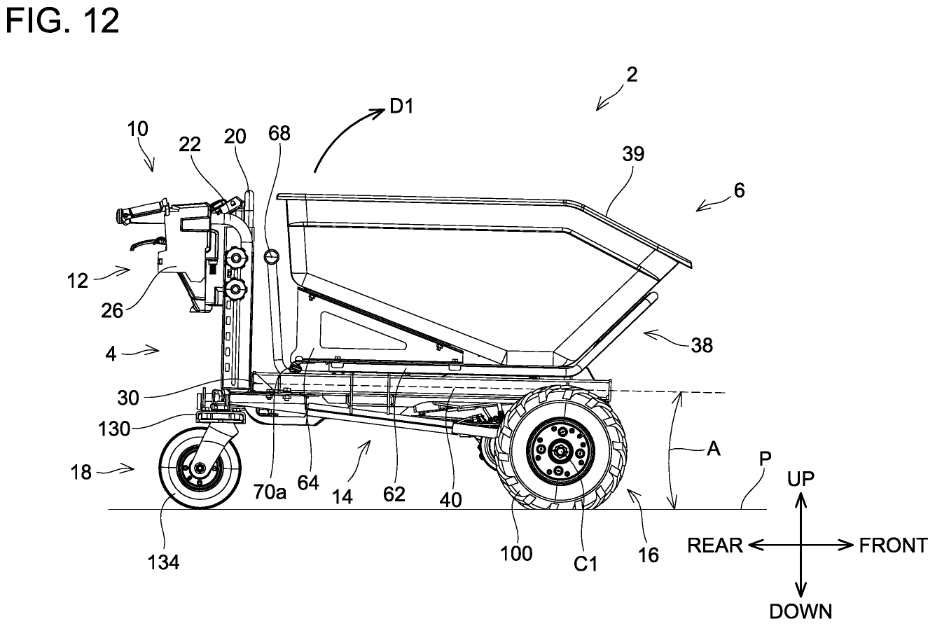

In S22, the control unit 150 determines whether the rear load F is no greater than a predetermined load Fp. The predetermined load Fp is a load by which the right rear wheel 134 and the left rear wheel 136 are predicted to lift from a ground P (see FIG. 12) if the actuator 32 continues the expanding operation. If the rear load F is less than or equal to the predetermined load Fp, the control unit 150 determines YES in S22 and the process proceeds to S24. On the other hand, if the rear load F is greater than the predetermined load Fp, the control unit 150 determines NO in S22 and the process proceeds to S30.

In S24, the control unit 150 switches the operation of the actuator 32 from the expanding operation to the contracting operation. In the present embodiment, the control unit 150 controls and causes the actuator 32 to execute the contracting operation over a predetermined time after the control unit 150 determined YES in S22. The predetermined time is, for example, a time that is required to reduce the current pivot angle between the fixed frame 30 and the pivotable frame 34 by 10 (degrees).

In S26, the control unit 150 stops the contracting operation of the actuator 32.

In S28, the control unit 150 causes the buzzer 12b to go off. Thereby, the user is able to know that the contracting operation was executed to prevent the right rear wheel 134 and the left rear wheel 136 from lifting from the ground P and that the operation of the actuator 32 was stopped. When S28 ends, the process of FIG. 10 ends.

In S30, the control unit 150 determines whether the lifting operation has been stopped. If the lifting operation has been stopped, the control unit 150 determines YES in S30 and the process proceeds to S32. On the other hand, if the lifting operation is being continued, the control unit 150 determines NO in S30 and the process returns to S12.

In S32, the control unit 150 stops the expanding operation of the actuator 32. When S32 ends, the process of FIG. 10 ends.

if determining NO in S10, the control unit 150 determines in S50 whether the lower portion of the receptacle operation switch 12a is being manipulated, that is, whether the lowering operation is being performed. If the lowering operation is being performed, the control unit 150 determines YES in S50 and the process proceeds to S52. On the other hand, if the lowering operation is not being performed, the control unit 150 determines NO in S50 and the process returns to S10.

In S52, the control unit 150 controls and causes the actuator 32 to execute the contracting operation.

In S54, the control unit 150 monitors whether the lowering operation has been stopped. If the lowering operation has been stopped, the control unit 150 determines YES in S54 and the process proceeds to S56.

In S56, the control unit 150 stops the contracting operation of the actuator 32. When S56 ends, the process of FIG. 10 ends.

(Operation of Cart 2)

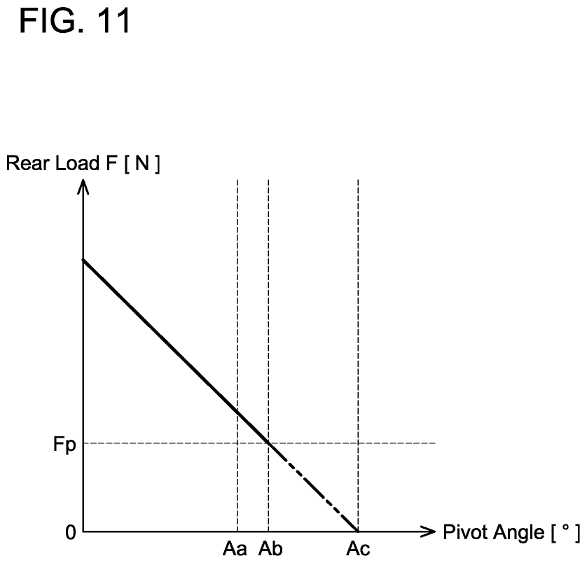

Next, referring to FIG. 11, how the cart 2 operates when argilliferous soil is in the bucket 39 will be described. In FIG. 11, the vertical axis shows the rear load F detected by the rear load sensor 138 and the horizontal axis shows pivot angles between the fixed frame 30 and the pivotable frame 34.

When the cart 2 receives the lifting operation by the user (YES in S10 of FIG. 10), it causes the actuator 32 to execute the expanding operation (S12). In this case, as the pivot angle increases, the soil in the bucket 39 moves forward and is then unloaded. In course of this process, the center of gravity of the cart 2 (including the soil in the bucket 39) shifts forward, and thus the load on the right front wheel 100 and the left front wheel 102 increases, while the load on the right rear wheel 134 and the left rear wheel 136 decreases. That is, the rear load decreases. At the time when the pivot angle is an angle Aa, a small amount of the soil remains in a lower portion of the bucket 39. This small-amount soil is adhering to the bucket 39. Thus, the soil adhering to the bucket 39 is not unloaded even when the pivot angle becomes larger than the angle Aa. As the pivot angle becomes larger than the angle Aa, the center of gravity of the cart 2 further shifts forward and the rear load F further decreases. Then, at the time when the pivot angle becomes an angle Ab, the rear load F becomes the predetermined load Fp. In this case, the cart 2 determines that the rear load F is less than or equal to the predetermined load Fp (YES in S22) and causes the actuator 32 to execute the contracting operation over the predetermined time. Thereby, the pivot angle is reduced and the rear load F increases. Then, when the predetermined time has elapsed since the cart 2 started causing the actuator 32 to execute the contracting operation, the cart 2 stops the contracting operation of the actuator 32 (S26) and causes the buzzer 12b to go off (S28). After this, the user unloads the soil adhering to the bucket 39 by using a shovel, etc. If dry sand is in the bucket 39, the sand will be unloaded completely before the rear load F becomes less than or equal to the predetermined load Fp.

If the expanding operation of the actuator 32 is continued even after the rear load F has become less than or equal to the predetermined load Fp, the rear load F further decreases as indicated by the double-dot chain line in FIG. 11. Then, at the time when the pivot angle becomes an angle Ac, the right rear wheel 134 and the left rear wheel 136 leave the ground P.

As described and illustrated in FIGS. 1 to 9, the cart 2 according to one embodiment comprises the right front wheel 100, the left front wheel 102, the right rear wheel 134, the left rear wheel 136, the fixed frame 30, the bucket 39 pivotable relative to the fixed frame 30, the rear load sensor 138 configured to detect the load applied to the right rear wheel 134 and the left rear wheel 136, and the control unit 150. The control unit 150 is configured to determine that the right rear wheel 134 and the left rear wheel 136 are predicted to lift from the ground P when the rear load F detected by the rear load sensor 138 becomes less than or equal to the predetermined load Fp (YES in S22 of FIG. 10). According to this configuration, the control unit 150 can determine that the right rear wheel 134 and the left rear wheel 136 are predicted to lift from the ground P by using the rear load F detected by the rear load sensor 138. Thus, even if an object in the bucket 39 is something that easily adheres to the bucket 39, it is possible to suppress the position of the center of gravity of the cart 2 from shifting forward to an extent that the right rear wheel 134 and the left rear wheel 136 of the cart 2 lift from the ground P. Thus, it is possible to suppress the right rear wheel 134 and the left rear wheel 136 of the cart 2 from lifting from the ground P and improve safety in using the cart 2.

As illustrated in FIG. 9, the cart 2 according to one embodiment comprises the buzzer 12b. As illustrated in FIG. 10, the control unit 150 causes the buzzer 12b to go off when determining that the right rear wheel 134 and the left rear wheel 136 are predicted to lift from the ground P (YES in S22). According to this configuration, the user is able to know that the right rear wheel 134 and the left rear wheel 136 can lift from the ground P in response to pivoting the bucket 39 relative to the fixed frame 30. Thus, it is possible to improve the safety in using the cart 2.

As illustrated in FIG. 6, the cart 2 according to one embodiment further comprises the actuator 32 configured to pivot the bucket 39 relative to the fixed frame 30. The control unit 150 is configured to control the operation of the actuator 32. According to this configuration, the user does not have to manually pivot the bucket 39 relative to the fixed frame 30. Thus, user convenience can be improved.

As illustrated in FIG. 10, under the state where the actuator 32 is in operation, the control unit 150 of the cart 2 according to one embodiment stops the operation of the actuator 32 (S26) when determining that the right rear wheel 134 and the left rear wheel 136 are predicted to lift from the ground P (YES in S22). According to this configuration, it is possible to suppress the right rear wheel 134 and the left rear wheel 136 from lifting from the ground P since the operation of the actuator 32 is stopped. Thus, it is possible to improve the safety in using the cart 2.

As illustrated in FIG. 10, when determining that the right rear wheel 134 and the left rear wheel 136 are predicted to lift from the ground P under the state where the actuator 32 is in operation and the angle between the fixed frame 30 and the bucket 39 is the angle Ab (YES in S22), the control unit 150 of the cart 2 according to one embodiment controls the operation of the actuator 32 such that the angle between the fixed frame 30 and the bucket 39 becomes smaller than the angle Ab (S24). According to this configuration, the control unit 150 reduces the angle between the fixed frame 30 and the bucket 39 when determining that the right rear wheel 134 and the left rear wheel 136 are predicted to lift from the ground P. Thereby, the position of the center of gravity of the cart 2 shifts rearward. Thus, it is possible to further ensure that the right rear wheel 134 and the left rear wheel 136 are prevented from lifting from the ground P.

(Correspondence Relationships)

The cart 2 is an example of “handcart”. The fixed frame 30 is an example of “support frame”. The bucket 39 is an example of “receptacle”. The rear load sensor 138 is an example of “load sensor”. The buzzer 12b is an example of “notifier”. The angle Ab is an example of “first angle”.

### Second Embodiment

A cart 2 according to the present embodiment is different from the cart 2 according to the first embodiment in that it comprises an angle sensor 238 (see FIG. 9) but does not comprise the rear load sensor 138. As illustrated in FIG. 12, the angle sensor 238 is configured to detect a frame angle A that is an angle of the fixed frame 30 in the front-rear direction relative to the ground P (an example of “reference surface”).

The control unit 150 according to the present embodiment determines in S22 of FIG. 10 whether the frame angle A detected by the angle sensor 238 is no less than a predetermined angle Ap. The predetermined angle Ap is an angle by which the right rear wheel 134 and the left rear wheel 136 are predicted to lift from the ground P if the actuator 32 continues the expanding operation, if the frame angle A is greater or equal to the predetermined angle Ap, the control unit 150 determines YES in S22 and the process proceeds to S24. On the other hand, if the frame angle A is less than the predetermined angle Ap, the control unit 150 determines NO in S22 and the process proceeds to S30.

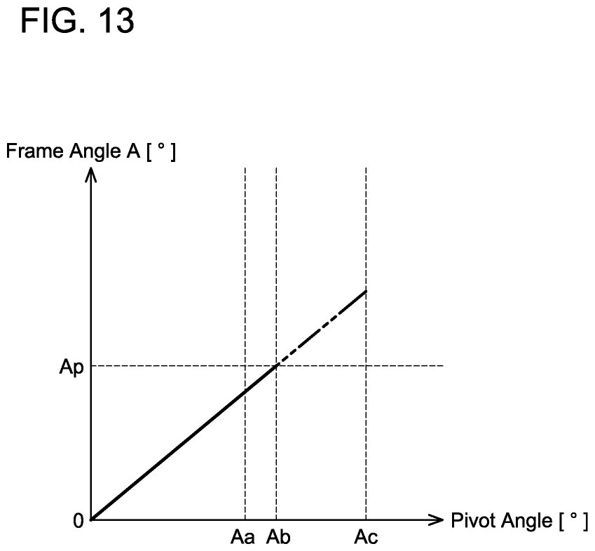

Referring to FIG. 13, how the cart 2 operates when argilliferous soil is in the bucket 39 in the present embodiment will be described. In FIG. 13, the vertical axis shows the frame angle A detected by the angle sensor 238 and the horizontal axis shows the pivot angles between the fixed frame 30 and the pivotable frame 34. When the argilliferous soil is in the bucket 39, portions of the right front wheel 100, the left front wheel 102, the right rear wheel 134, and the left rear wheel 136 that are in contact with the ground P are slightly deformed.

When the cart 2 receives the lifting operation by the user (YES in S10 of FIG. 10), it causes the actuator 32 to execute the expanding operation (S12). In this case, as the pivot angle increases, the soil in the bucket 39 moves forward and is then unloaded. In course of this process, the center of gravity of the cart 2 (including the soil in the bucket 39) shifts forward, and thus the load on the right front wheel 100 and the left front wheel 102 increases, while the load on the right rear wheel 134 and the left rear wheel 136 decreases. Accordingly, the deformation in lower portions of the right rear wheel 134 and the left rear wheel 136 decreases. Thus, a rear portion of the base plate 130 is elevated and the frame angle A increases. At the time when the pivot angle is an angle Aa, a part of the soil remaining in the lower portion of the bucket 39 is adhering to the bucket 39. Thus, the soil adhering to the bucket 39 is not unloaded even when the pivot angle becomes larger than the angle Aa. In this case, as the pivot angle becomes larger than the angle Aa, the center of gravity of the cart 2 further shifts forward, the load on the right rear wheel 134 and the left rear wheel 136 further decreases, and the deformation of the right rear wheel 134 and the left rear wheel 136 further decreases. Thus, the frame angle A further increases. Then, at the time when the pivot angle becomes an angle Ab, the frame angle A becomes the predetermined angle Ap. At this time, the cart 2 determines that the frame angle A is greater than or equal to the predetermined angle Ap (YES in S22) and causes the actuator 32 to execute the contracting operation over a predetermined time. Thereby, the pivot angle decreases and the frame angle A decreases. Then, when the predetermined time has elapsed since the cart 2 started causing the actuator 32 to execute the contracting operation, the cart 2 stops the contracting operation of the actuator 32 (S26) and causes the buzzer 12b to go off (S28). After this, the user unloads the soil adhering to the bucket 39 therefrom by using a shovel, etc.

If the expanding operation of the actuator 32 is continued even after the frame angle A has become greater than the predetermined angle Ap, the frame angle A further increases as indicated by the double-dot chain line in FIG. 13. Then, at the time when the pivot angle becomes an angle Ac, the right rear wheel 134 and the left rear wheel 136 leave the ground P.

As described and illustrated in FIGS. 1 to 9, the cart 2 according to one embodiment comprises the right front wheel 100, the left front wheel 102, the right rear wheel 134, the left rear wheel 136, the fixed frame 30, the bucket 39 pivotable relative to the fixed frame 30, the angle sensor 238 configured to detect the frame angle A of the fixed frame 30 in the front-rear direction relative to the ground P, and the control unit 150. The control unit 150 is configured to determine that the right rear wheel 134 and the left rear wheel 136 are predicted to lift from the ground P when the frame angle A detected by the angle sensor 238 becomes greater than or equal to the predetermined angle Ap (YES in S22 of FIG. 10). According to this configuration, the control unit 150 can determine that the right rear wheel 134 and the left rear wheel 136 are predicted to lift from the ground P by using the frame angle A of the fixed frame 30 in the front-rear direction relative to the ground P. Thus, even if an object in the bucket 39 is something that easily adheres to the bucket 39, it is possible to suppress the position of the center of gravity of the cart 2 from shifting forward to an extent that the right rear wheel 134 and the left rear wheel 136 of the cart 2 lift from the ground P. Thus, it is possible to suppress the right rear wheel 134 and the left rear wheel 136 of the cart 2 from lifting from the ground P and improve the safety in using the cart 2.

### Third Embodiment

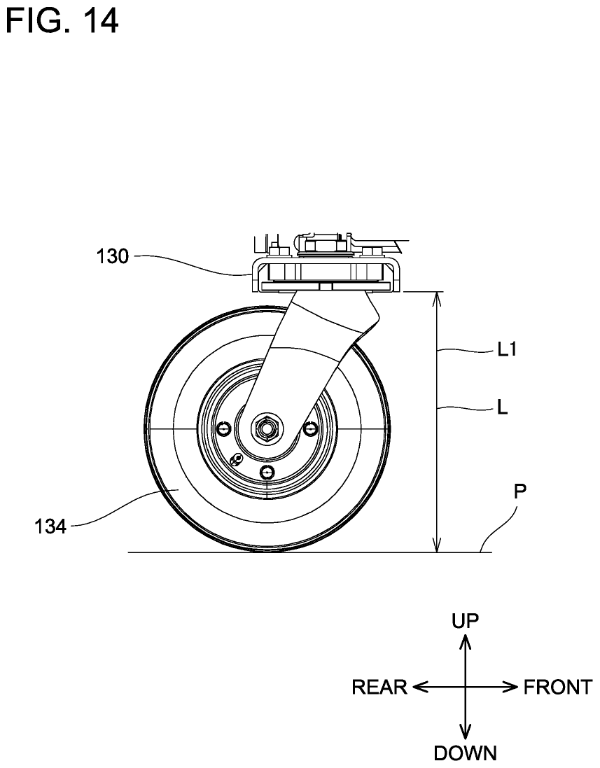

A cart 2 according to the present embodiment is different from the cart 2 according to the first embodiment in that it comprises a distance sensor 338 (see FIG. 9) but does not comprise the rear load sensor 138. The distance sensor 338 is disposed, for example, on a lower surface of the base plate 130. As illustrated in FIG. 14, the distance sensor 338 is configured to detect a distance L1 between the base plate 130 and the ground P. The control unit 150 specifies a displacement S of the right rear wheel 134 and the left rear wheel 136 by using the distance L1. The control unit 150 stores a reference distance L that is the distance between the base plate 130 and the ground P when portions of the right rear wheel 134 and the left rear wheel 136 that are in contact with the ground P are not deformed. The control unit 150 specifies the displacement S by subtracting the distance L1 detected by the distance sensor 338 from the reference distance L.

The control unit 150 according to the present embodiment determines in S22 of FIG. 10 whether the displacement S of the right rear wheel 134 and the left rear wheel 136 is no greater than a predetermined displacement Sp. The predetermined displacement Sp is a value by which the right rear wheel 134 and the left rear wheel 136 are predicted to lift from the ground P if the expanding operation of the actuator 32 is continued. If the displacement S is less than or equal to the predetermined displacement Sp, the control unit 150 determines YES in S22 and the process proceeds to S24. On the other hand, if the displacement S is greater than the predetermined displacement Sp, the control unit 150 determines NO in S22 and the process proceeds to S30.

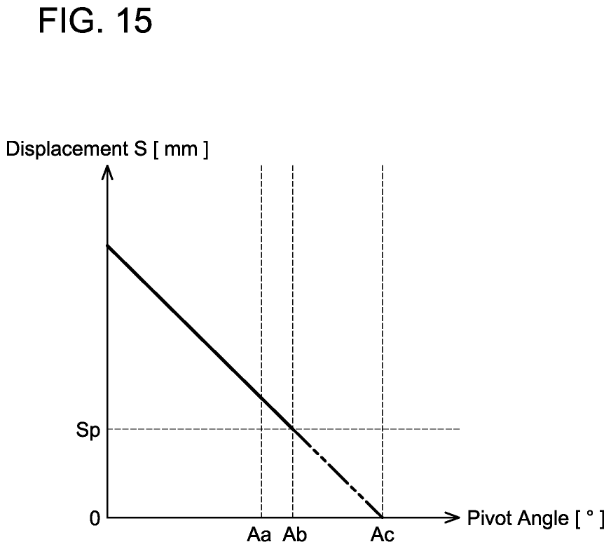

Referring to FIG. 15, how the cart 2 operates when argilliferous soil is in the bucket 39 will be described. In FIG. 15, the vertical axis shows the displacement S of the right rear wheel 134 and the left rear wheel 136, and the horizontal axis shows pivot angles between the fixed frame 30 and the pivotable frame 34. When the argilliferous soil is in the bucket 39, portions of the right front wheel 100, the left front wheel 102, the right rear wheel 134, and the left rear wheel 136 that are in contact with the ground P are slightly deformed.

When the cart 2 receives the lifting operation by the user (YES in S10 of FIG. 10), it causes the actuator 32 to execute the expanding operation (S12). In this case, as the pivot angle increases, the soil in the bucket 39 moves forward and is then unloaded from the bucket 39. In course of this process, the center of gravity of the cart 2 (including the soil in the bucket 39) shifts forward, and thus the load on the right front wheel 100 and the left front wheel 102 increases, while the load on the right rear wheel 134 and the left rear wheel 136 decreases. Accordingly, the deformation in the lower portions of the right rear wheel 134 and the left rear wheel 136 decreases. Thus, the distance between an upper end of the right rear wheel 134 and the ground P increases and the displacement S decreases. At the time when the pivot angle is an angle Aa, a part of the soil remaining in the lower portion of the bucket 39 is adhering to the bucket 39. Thus, the soil adhering to the bucket 39 is not unloaded therefrom even when the pivot angle becomes larger than the angle Aa. In this case, as the pivot angle becomes larger than the angle Aa, the center of gravity of the cart 2 further shifts forward, the load on the right rear wheel 134 and the left rear wheel 136 further decreases, and the deformation of the right rear wheel 134 and the left rear wheel 136 further decreases. Thus, the displacement S further decreases. Then, at the time when the pivot angle becomes an angle Ab, the displacement S becomes the predetermined displacement Sp. In this case, the cart 2 determines that the displacement S is less than or equal to the predetermined displacement Sp (YES in S22) and causes the actuator 32 to execute the contracting operation over a predetermined time. Thereby, the pivot angle is reduced and the displacement S increases. When the predetermined time has elapsed since the cart 2 started causing the actuator 32 to execute the contracting operation, the cart 2 stops the contracting operation of the actuator 32 (S26) and causes the buzzer 12b to go off (S28). After this, the user unloads the soil adhering to the bucket 39 therefrom by using a shovel, etc.

If the expanding operation of the actuator 32 is continued even after the displacement S has become less than or equal to the predetermined displacement Sp, the displacement S further decreases as indicated by the double-dot chain line in FIG. 15. Then, at the time when the pivot angle becomes an angle Ac, the right rear wheel 134 and the left rear wheel 136 leave the ground P.

As described and illustrated in FIGS. 1 to 9, the cart 2 according to one embodiment comprises the right front wheel 100, the left front wheel 102, the right rear wheel 134, the left rear wheel 136, the fixed frame 30, the bucket 39 pivotable relative to the fixed frame 30, the distance sensor 338 used for detecting the displacement of the right rear wheel 134, and the control unit 150. The control unit 150 is configured to determine that the right rear wheel 134 and the left rear wheel 136 are predicted to lift from the ground P when the displacement S becomes smaller than or equal to the predetermined displacement Sp (YES in S22 of FIG. 10). According to this configuration, the control unit 150 can determine that the right rear wheel 134 and the left rear wheel 136 are predicted to lift from the ground P by using the displacement of the right rear wheel 134. Thus, even if an object in the bucket 39 is something that easily adheres to the bucket 39, it is possible to suppress the position of the center of gravity of the cart 2 from shifting forward to an extent that the right rear wheel 134 and the left rear wheel 136 of the cart 2 lift from the ground P. Thus, it is possible to suppress the right rear wheel 134 and the left rear wheel 136 of the cart 2 from lifting from the ground P and improve the safety in using the cart 2.

(First Variant) The front wheel unit 16 of the cart 2 according to the first embodiment may comprise a front load sensor. The front load sensor may be disposed, for example, on the right drive shaft, the left drive shaft and the like. In this variant, the control unit 150 may execute the processes of S24 to S26, for example, when the rear load F is smaller than or equal to the predetermined load Fp and a front load detected by the front load sensor is larger than or equal to a second predetermined load. Alternatively, the control unit 150 may execute the processes of S24 to S26, for example, when the value that is obtained by subtracting the rear load F from the front load is larger than a predetermined value.

(Second Embodiment) S28 in FIG. 10 may be omitted. In this variant, the “notifier” may be omitted.

(Third Variant) The “notifier” is not limited to the buzzer 12b. It may be a speaker, a display, etc.

(Fourth Variant) The carts 2 may not comprise the actuator 32.

(Fifth Variant) At least one of the process of S24 and the process of S26 in FIG. 10 may be omitted.

(Sixth Variant) The “handcart” may be a three-wheeled cart, for example.

What is claimed is:

1. A handcart comprising:
a front wheel;
a rear wheel;
a support frame supporting the front wheel and the rear wheel;
a receptacle pivotable relative to the support frame;
a load sensor configured to detect a load applied to the rear wheel; and
a control unit,
wherein when the load detected by the load sensor becomes less than or equal to a predetermined load, the control unit is configured to determine that the rear wheel is predicted to lift from a ground.

2. The handcart according to claim 1, further comprising a notifier,
wherein the control unit is configured to activate the notifier when determining that the rear wheel is predicted to lift from the ground.

3. The handcart according to claim 1, further comprising an actuator configured to pivot the receptacle relative to the support frame,
wherein the control unit is configured to control an operation of the actuator.

4. The handcart according to claim 3, wherein
under a state where the actuator is in operation, the control unit is configured to stop the operation of the actuator when determining that the rear wheel is predicted to lift from the ground.

5. The handcart according to claim 3, wherein
when determining that the rear wheel is predicted to lift from the ground under a state where the actuator is in operation and an angle between the support frame and the receptacle is a first angle, the control unit is configured to control the operation of the actuator such that the angle between the support frame and the receptacle becomes a second angle that is smaller than the first angle.

6. A handcart comprising:
a front wheel;
a rear wheel;
a support frame supporting the front wheel and the rear wheel;
a receptacle pivotable relative to the support frame;
an angle sensor configured to detect an angle of the support frame with respect to a reference plane in a front-rear direction; and
a control unit,
wherein when the angle detected by the angle sensor becomes greater than or equal to a predetermined angle, the control unit is configured to determine that the rear wheel is predicted to lift from a ground.

7. The handcart according to claim 1, further comprising:
wherein the control unit is configured to activate the notifier when determining that the rear wheel is predicted to lift from the ground.

8. The handcart according to claim 1, further comprising an actuator configured to pivot the receptacle relative to the support frame,
wherein the control unit is configured to control an operation of the actuator.

9. The handcart according to claim 8, wherein
under a state where the actuator is in operation, the control unit is configured to stop the operation of the actuator when determining that the rear wheel is predicted to lift from the ground.

10. The handcart according to claim 8, wherein
when determining that the rear wheel is predicted to lift from the ground under a state where the actuator is in operation and an angle between the support frame and the receptacle is a first angle, the control unit is configured to control the operation of the actuator such that the angle between the support frame and the receptacle becomes a second angle that is smaller than the first angle.

11. A handcart comprising:
a front wheel;
a rear wheel;
a support frame supporting the front wheel and the rear wheel;
a receptacle pivotable relative to the support frame;
a displacement detector for specifying a displacement of the rear wheel; and
a control unit,
wherein when the displacement becomes smaller than or equal to a predetermined value, the control unit is configured to determine that the rear wheel is predicted to lift from a ground.

12. The handcart according to claim 11, further comprising a notifier,
wherein the control unit is configured to activate the notifier when determining that the rear wheel is predicted to lift from the ground.

13. The handcart according to claim 11, further comprising an actuator configured to pivot the receptacle relative to the support frame,
wherein the control unit is configured to control an operation of the actuator.

14. The handcart according to claim 13, wherein
under a state where the actuator is in operation, the control unit is configured to stop the operation of the actuator when determining that the rear wheel is predicted to lift from the ground.

15. The handcart according to claim 13, wherein
when determining that the rear wheel is predicted to lift from the ground under a state where the actuator is in operation and an angle between the support frame and the receptacle is a first angle, the control unit is configured to control the operation of the actuator such that the angle between the support frame and the receptacle becomes a second angle that is smaller than the first angle.
